(19) United States
(12) Patent Application Publication
(10) Pub. No.: US 2006/0225295 A1
(43) Pub. Date: Oct. 12, 2006

(54) Positioning device for a reference body

(75) Inventors: Gerhard Kramer, Penzing/Untermuhlhausen (DE); Jurgen Klasmeier, Landsberg (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: RATIONAL AG, Landsberg/Lech (DE)

(21) Appl. No.: 10/565,568

(22) PCT Filed: Jul. 20, 2004
(86) PCT No.: PCT/DE04/01568

§ 371 Date: Jan. 23, 2006

(30) Foreign Application Priority Data
Jul. 24, 2003 (DE) 203 11 408.6

(51) Int. Cl. B43L 7/10

(52) U.S. Cl. 33/455

(57) ABSTRACT

The invention relates to a positioning device for positioning a reference body on a rack frame for a cooking appliance, by means of which measured values of a cooking process can be detected by a sensor, which comprises a frame for holding at least one insertion column with a plurality of insertion levels, whereby said positioning device is secured to the rack frame by means of at least two joining pieces which extend substantially vertically upwards or downwards from a base element or upper element of the frame.

### RELATED APPLICATIONS

This is the U.S. national phase of International Application No. PCT/DE2004/001568 filed Jul. 20, 2004 , the entire disclosure of which is incorporated herein by reference and claims priority to German application number 203 11 408.6 filed Jul. 24, 2003.

### TECHNICAL FIELD

The present application concerns a positioning device for positioning of a reference body in a cooking appliance.

### BACKGROUND ART

Reference bodies are frequently arranged in a cooking appliance to control a cooking process within the appliance in order to be able to determine corresponding measured values of the cooking process via these reference bodies, these values then being generalized and with which control of a cooking process is possible. The measured values of such reference bodies can be determined via a sensor or cooking process sensor.

For example, the previously unpublished DE 103 09 485 deals with a method for controlling the cooking process in which the total energy required for cooking or regeneration of a cooked product can be optimally adjusted. The climate in the cooking space is adjusted as a function of the corresponding heat input, especially in a reference body, which prevents the cooked product from drying out on its surface or being adversely affected in its quality by condensate puddles. The climate in the cooking space can be regulated in particular as a function of the temperature behavior of the reference body, preferably with consideration of a correlation determined before the cooking process with the temperature behavior of a type of cooked product, an amount of cooked product, a cooked product weight, a cooked product size and/or cooking pretreatment of a cooked product. For this purpose a sensor is positioned in or on the reference body, which is connected to a control and/or regulation unit of the cooking appliance. This sensor, for example, can be a cooking process sensor, which is known from DE 199 450 21 A1.

In particular, cooking appliances used in large kitchens often contain rack frames or rack frame carts on which a cooked product can be cooked or regenerated on a number of insertion levels. It is obvious that corresponding measured values to control cooking products cannot be individually determined for each individual cooked product arranged on an insertion level of the rack frame. A reference body can therefore advantageously be arranged within the cooking space of the cooking appliance, with which measured values can be determined generally within the cooking space and with which correlations with the cooked product and the cooking process are possible. Since the measured values determined via the reference body should correspond as well as possible to the measured values that the cooked products arranged on the insertion levels actually have, the reference body should be arranged as close as possible to the cooked products.

However, it must then be kept in mind that the arrangement of the reference body within the cooking space must be user-friendly and safe. In particular, when an additional sensor or cooking process sensor is to be arranged together with the reference body within the cooking space in the vicinity of the cooked product, the user-friendliness and especially cable length of such a sensor or cooking process sensor must be considered so that the cable does not touch the cooked product. Undesired contamination of the cooked product during arrangement of the reference body is to be avoided.

In the prior art, sensor positioning devices are also known that permit positioning of a sensor with at least one rotational degree of freedom and at least one translational degree of freedom for introduction into the cooked product, for example, in gastronomy containers between a number of rails of a suspension ladder, in which height adjustment and therefore allocation to one rail or a pair of rails from two opposite rails within a cooking space at one height is possible in addition to rotation and displacement of the sensor relative to said rails or said pair of rails, for example, as described in the not previously published PCT/EP03-01491.

### SUMMARY OF THE DISCLOSURE

It is therefore the task of the present disclosure to overcome the shortcomings of the prior art and especially provide a positioning device for positioning a reference body within a cooking appliance, which can be arranged user-friendly and safely in the vicinity of the cooked product being cooked or regenerated without causing contamination of the cooked product by the reference body or components connected to it, for example, a cable.

The task is solved by a positioning device for positioning of a reference body, via which measured values of a cooking process can be detected, on a rack frame for a cooking appliance, which has a frame to hold at least one insertion column with a number of insertion levels, the positioning device being fastened via at least two joining pieces to the rack frame, which extend essentially at right angles upward or downward from a base element or upper element of the frame.

It is then prescribed that the positioning device has a section, especially a beam-or plate-like section, running essentially horizontally between the joining pieces.

It can further be prescribed that the positioning device be arranged roughly in the center of the height of the rack frame.

It is preferred that the positioning device has a recess, preferably in the center between the joining pieces to accommodate the reference body.

It can then be prescribed that the recess has a mounting device for the reference body, like clamps, boots, hook-in devices, snap-in devices or the like.

It is also proposed that the positioning device has a sleeve that extends from the recess and has an opening that discharges into the recess.

The positioning device can comprise metal.

In one variant it is proposed that the reference body be a ceramic, clay, porcelain, Teflon or carbon fiber tube, or the reference body comprise a granulate filled sleeve, especially encapsulated.

It is also particularly preferred that the reference body is essentially fully enclosed by the sleeve, whose opening extends laterally along the longitudinal direction.

It can also be prescribed that the sleeve has an opening in the bottom.

It is preferably proposed that the reference body be arranged at an angle with reference to the joining piece, preferably at an angle of about 45°.

In another variant it is proposed that at least one sensor and/or cooking process sensor be arranged in and/or on the reference body, the sensor or cooking process sensor being operatively connected to a control and/or regulation unit of the cooking appliance.

It is then preferred that at least one climate parameter, including a temperature value within the cooking appliance, a temperature rise, a moisture content, a moisture rise and/or the like can be detected via the sensor or cooking process sensor.

It is also preferably prescribed that the measured values of the reference body can be used to determine the dew point.

The disclosed apparatus is based on the surprising finding that, because of the special arrangement of the positioning device on a rack frame for a cooking appliance, an optimal arrangement of a reference body can be achieved, which is user-friendly and safe. In particular undesired contamination of the cooked product arranged on the insertion levels of the rack frame is avoided. The reference body is arranged with the positioning device in the immediate vicinity of the cooked product. However this arrangement does not lie so far within the rack frame that a cable, to which a sensor or cooking process sensor is connected, would be too short and therefore would have to be pulled over or across the insertion levels, which undoubtedly leads to contamination of the cooked product. Instead the arrangement of the reference body is possible in simple fashion on the rack frame and requires no excessive demands.

The reference body can preferably be inserted simply into a recess of the positioning device, in which a mounting device, especially in the form of a sleeve or clamp, can be provided in order to secure the reference body in the positioning device. The reference body with particular preference is a hollow ceramic tube surrounded by a metal sleeve belonging to the positioning device, which is at least partially opened laterally in its longitudinal direction. A closed metal sleeve would distort the measured value, since the metal and only then the ceramic tube would be heated. With particular preference the bottom of the metal sleeve is also provided with an opening, which is advantageous for the case in which the ceramic tube is to permanently remain on the rack frame. With this opening, cleaning the cooking appliance would be possible by self-cleaning, since corresponding cleaning liquids could flow out without a problem from the bottom opening.

A sensor and/or cooking process sensor is also preferably provided in and/or on the reference body. In the preferred hollow ceramic tube, this sensor or cooking process sensor can be inserted in the cavity. If the sensor or cooking process sensor is connected to a control and/or regulation unit of the cooking appliance, a cooking process can be simply controlled by recording the measured values of the reference body.

The reference body can have a length of about 80 to about 120 mm, preferably about 100 mm, an outside diameter of about 10 to about 12 mm, preferably about 11 mm, and optionally an inside diameter of about 3 to about 5 mm, preferably about 4 mm .

### BRIEF DESCRIPTION OF THE DRAWINGS

Further features and advantages of the invention are apparent from the following detailed description of a preferred variant, with reference to the schematic drawings in which:

FIG. 1 shows a perspective view of a rack frame on which a positioning device is arranged;

FIG. 2 shows an enlarged cut-out of the area designated x of the rack frame depicted in FIG. 1; and

FIG. 3 shows a cross-section through the rack frame according to FIG. 1 along line A-A.

### DETAILED DESCRIPTION

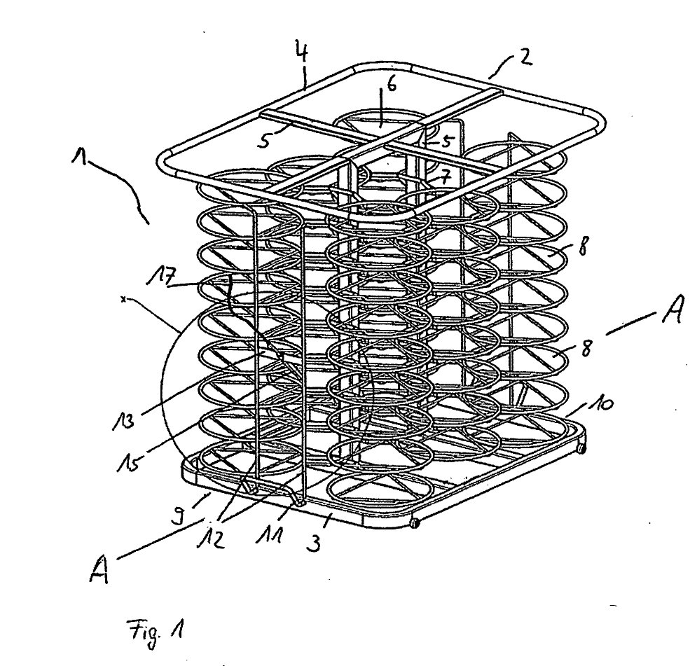

FIG. 1 shows a rack frame 1, which has a frame 2 including a base frame 3, an upper frame 4 and joining struts 5. Six insertion columns 6 are integrated within the frame 2, which are fastened via cross bars 7 to the joining struts 5 and therefore to the frame 2. Each insertion column 6 has a number of insertion levels 8, which are defined by an annular shape to accommodate a plate (not shown) or the like with a cooked product. The rack frame 1 is a rack frame cart. However a non-movable rack frame can naturally also be used.

The base frame 3 has a handle 11 on its front side 9 and its back side 10, which can be gripped during movement of the rack frame 1. Two joining pieces 12 extend essentially vertically upward from the front side 9 of the base frame 3. The joining pieces 12 are then arranged so that they run essentially between two insertion columns 6 along them. It is naturally also conceivable that the joining pieces 12 extend not only vertically from the base frame 3 but can also be bent initially from the base frame 3 somewhat into the rack frame 1 to then run more narrowly between the insertion column 6. This leads to an even closer arrangement of a reference body to a cooked product, as explained below. In particular, in plates with large diameter, which are to be positioned in the insertion column 6 and insertion levels 8, the essentially vertical arrangement of joining pieces 12 depicted in FIG. 1 is preferred. Naturally, the joining pieces 12 can also extend essentially vertically downward from the upper frame 4.

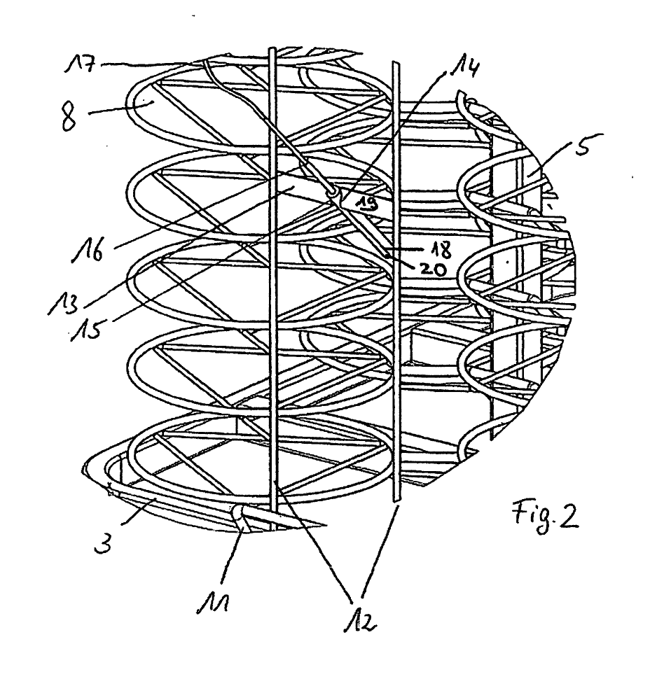

A positioning device 13 for a reference body 15 is arranged between the two joining pieces 12 at about half the height of the rack frame 1. This positioning device 13 includes a beam 18 running essentially horizontally between the two joining pieces 12 and a recess 14 arranged preferably in the center in beam 18. The positioning device 13 includes, as can be gathered in particular from FIG. 2, a sleeve 19 open on one side, which encloses a reference body 15, which can be made as a ceramic tube. The corresponding opening 20 in sleeve 19 then represents an extension of recess 14 and permits simple insertion of reference body 15, just like the recess 14.

The reference body 15 is introduced into the sleeve 19 by insertion into the opening 20 and the recess 14, as is apparent from FIG. 2. Reference body 15 in turn is designed to be hollow or tubular so that a sensor 16 can be inserted into the corresponding cavity of the reference body 15, with which measured values of the reference body 15 can be determined.

As follows in particular from FIG. 2, the reference body 15 is arranged very close to the insertion levels 8 that contain the cooked product (not shown), but without permitting contamination of the cooked product. Reference body 15 as well as sensor 16 can be inserted in a user-friendly and safe fashion into positioning device 13, in which a cable 17 and sensor 16 need not be pulled over or through the insertion levels 8. As is also readily apparent from FIG. 2, the joining pieces 12 also serve as cable deflectors, since they prevent the cable from easily reaching the insertion levels 8.

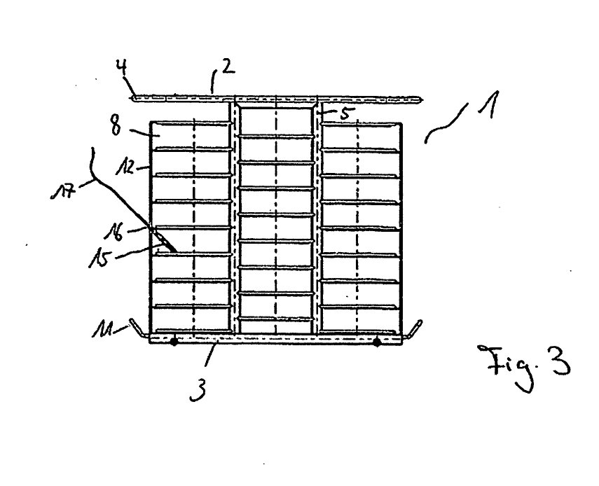

FIG. 3 shows a cross-section through the rack frame 1 according to FIG. 1. The angled arrangement of the reference body 15 relative to joining pieces 12 is shown particularly well here, preferably at an angle of about 45°, which permits an even better approach of the reference body 15 to the insertion levels 8.

The features of the invention disclosed in the above description and in the claims and drawings can be but are not necessarily essential both individually and in any combination for implementation of the invention in its different variants.

### LIST OF REFERENCE NUMBERS

1 Rack frame
2 Frame
3 Base frame
4 Upper frame
5 Joining struts
6 Insertion column
7 Crossbar
8 Insertion level
9 Front side
10 Back side
11 Handle
12 Joining piece
13 Positioning device
14 Recess
15 Reference body
16 Sensor
17 Cable
18 Beam
19 Sleeve
20 Opening

1. Positioning device for the positioning of a reference body, via which measured values of a cooking process can be detected, on a rack frame for a cooking appliance, which has a frame including a base frame and/or an upper frame and which holds at least one insertion column with a plurality of insertion levels, in which the positioning device comprising:
a positioner attached to the rack frame via at least two joining pieces, which extend essentially vertically upward or downward from the base frame or the upper frame of the frame.

2. Positioning device according to claim 1, wherein the positioner has a beam- or plate-like section running essentially horizontally between the at least two joining pieces.

3. Positioning device according to claim 1, wherein the positioner is arranged roughly in the center of the height of the rack frame.

4. Positioning device according to claim 1, wherein the positioner has a recess to receive the reference body.

5. Positioning device according to claim 4, wherein the recess has a holding device for the reference body.

6. Positioning device according to claim 4, wherein the positioner has a sleeve that extends from the recess.

7. Positioning device according to claim 1, wherein the positioner comprises metal.

8. Positioning device according to claim 1, wherein the reference body is a ceramic, clay, porcelain, Teflon or carbon fiber tube, or the reference body comprises a granulate filled.

9. Positioning device according to claim 6 wherein the reference body is essentially fully enclosed by the sleeve, and an opening of the sleeve extends laterally along the longitudinal direction.

10. Positioning device according to claim 9 wherein the sleeve has a further opening on the bottom.

11. Positioning device according to claim 1, wherein the reference body is arranged angled with reference to one of the at least two joining pieces.

12. Positioning device according to claim 1, further including at least one sensor and/or cooking process sensor arranged in and/or on the reference body, the sensor and/or the cooking process sensor being operatively connected to a control and/or regulation unit of the cooking appliance.

13. Positioning device according to claim 12, wherein the sensor and/or the cooking process sensor detects at least one climate parameter.

14. Positioning device according to claim 1, wherein the measured values of the reference body can be used to determine a dew point.

15. Positioning device according to claim 4, wherein the recess is centered between the at least two joining pieces to receive the reference body.

16. Positioning device according to claim 5, wherein the holding device for the reference body comprises one of clamps, boots, hook-in devices or snap-in devices.

17. Positioning device according to claim 1, wherein the reference body comprises a granulate filled sleeve and wherein the granulate is encapsulated.

18. Positioning device according to claim 6, wherein the sleeve has an opening that discharges into the recess.

19. Positioning device according to claim 1, wherein the reference body is arranged angled with reference to one of the at least two joining pieces at an angle of about 45°.

20. Positioning device according to claim 13, wherein the at least one climate parameter comprises one of a temperature value within the cooking appliance, a temperature rise, a moisture content, or a moisture rise.

21. Positioning device according to claim 4, wherein the recess is positioned between the at least two joining pieces.

22. A cooking appliance, comprising:
a rack frame including a base frame and/or an upper frame and at least one insertion column with a plurality of insertion levels;
a reference body via which measured values of a cooking process can be detected; and
a positioning device for the positioning the reference body, the positioning device being attached to the rack frame via two joining pieces which extend essentially vertically upward or downward from the base frame or the upper frame.

23. The cooking appliance of claim 22, wherein the positioning device has a beam-or plate-like section running essentially horizontally between the two joining pieces.

24. The cooking appliance of claim 22, wherein the positioning device is arranged roughly in the center of the height of the rack frame.

25. The cooking appliance of claim 22, wherein the positioning device includes a recess disposed between the two joining pieces to receive the reference body.

26. The cooking appliance of claim 25, wherein the recess has a holding device that holds the reference body.

27. The cooking appliance of claim 26, wherein the positioning device includes a sleeve extending from the recess.

28. The cooking appliance of claim 22, wherein the reference body is a ceramic, a clay, a porcelain, a Teflon or a carbon fiber tube, or the reference body comprises a granulate filled sleeve.

29. The cooking appliance of claim 22, wherein the reference body is arranged angled with reference to at least one of the two joining pieces.

30. The cooking appliance of claim 22, further including at least one sensor arranged in and/or on the reference body, the sensor being operatively connected to a control and/or a regulation unit of the cooking appliance.

31. The cooking appliance of claim 30, wherein the sensor detects at least one climate parameter, comprising one of a temperature value within the cooking appliance, a temperature rise, a moisture content, or a moisture rise.
